(19) United States
(12) Patent Application Publication
(10) Pub. No.: US 2013/0167694 A1
(43) Pub. Date: Jul. 4, 2013

(54) ROD TOOL STRUCTURE

(71) Applicant: Leo Shih, Taichung (TW)

(72) Inventor: Leo Shih, Taichung (TW)

(21) Appl. No.: 13/338,259

(22) Filed: Dec. 28, 2011

(51) Int. Cl. B25G 1/04; B25G 3/10; B25G 1/02

(52) U.S. Cl. 81/489

(57) ABSTRACT

A rod tool structure contains a grip portion to be held by a hand; an extendible and retractable tube connected with a front end of the grip portion to adjust an operation length; a flexible member mounted on a front end of the extendible and retractable tube and twisted at various angles; a tool member connected with a front end of the flexible member to be operated and used.

### BACKGROUND OF THE INVENTION

1. Field of the Invention

The present invention relates to a rod tool structure to adjust an operation length and angle of a body so that various tool members matches with the rod tool structure based on requirement.

2. Description of the Prior Art

With reference to FIGS. 1 and 2, a conventional rod tool includes a body 10 with a mirror, the body 10 includes a grip portion 11 having a multi-section extendible and extractable tube 12 connected with a front end of the grip portion 11 to adjust an operation length of the rod tool, the extendible and extractable tube 12 includes a first knob 121 disposed on a front end thereof, a connecting member 13 having two opposite plates 131, 132 and a bolt 133. The two opposite plates 131, 132 include cavities 1311, 1312, 1321, 1322 formed on front and rear ends thereof respectively, the cavities 1311, 1321 of the rear ends of the plates 131, 132 fit with the first knob 121 of the extendible and extractable tube 12, the cavities 1311, 1321 of the front ends of the plates 131, 132 fit with a second knob 141 of a tool member 14, and a bolt 133 presses the first knob 121 of the extendible and extractable tube 12 and the second knob 141 of the tool member 14. The tool member 14 includes the mirror 142. In operation, the operation length of the rod tool is adjusted by using the extendible and extractable tube 12, and the cavities 1312, 1322 and the first knob 121 are used to make a first-section angular adjustment, the cavities 1311, 1321 and the second knob 141 are served to make a second-section angular adjustment, such that the mirror 142 of the tool member 14 is capable of being used in a specific condition to make a universal adjustment. The body 10 of the rod tool is used in the automotive repair and maintenance, and more particularly to a narrow space of an engine room. In operation, the cavities 1312, 1322 and the first knob 121 are applied to make the first-section angular adjustment, and the cavities 1311, 1321 and the second knob 141 are used to make the section-section angular adjustment, obtaining the universal adjustment. However, the angular adjustment is inconvenient, and the assembly of the connecting member 13, the first knob 121, and the second knob 141 is complicated. In addition, the disengagement of the cavities 1311, 1321, 1312, 1322 from the first knob 121 and the second knob 141 respectively will happen after using the rod tool in a long period of time.

As shown in FIGS. 3 and 4, a rod tool 20 includes a magnetic member and a grip portion 21, the grip portion 21 includes a multi-section extendible and retractable tube 22 connected with a front end thereof to adjust an operation length of the rod tool, the extendible and retractable tube 22 includes a first knob 221 disposed on a front end thereof, a connecting member 23 having two opposite plates 231, 232 and a bolt 233, the two opposite plates 231, 232 include cavities 2311, 2312, 2321, 2322 formed on front and rear ends thereof individually, the cavities 2312, 2322 of the rear ends of the two opposite plates 231, 232 fit with the first knob 221 of the extendible and retractable tube 22, the cavities 2311, 2321 of the front ends of the two opposite plates 231, 232 fit with a second knob 241 of a tool member 24, and the bolt 233 presses the first knob 221 of the extendible and retractable tube 22 and the second knob 241 of the tool member 24, the tool member 24 includes a magnetic member to attract an object. In operation, the operation length of the rod tool is adjusted by ways of the extendible and retractable tube 22, and the cavities 2312, 2322 and the first knob 221 are served to make a first-section angular adjustment, the cavities 2311, 2321 and the second knob 241 are used to make a second-section angular adjustment, such that the magnetic member 242 of the tool member 24 is applied in a specific condition to make universal adjustment. The magnetic member 242 of the rod tool 20 is applied to attract the object. In operation, the cavities 2312, 2322 and the first knob 221 are served to make the first-section angular adjustment, the cavities 2311, 2321 and the knob 241 are used to make the second-section angular adjustment, thus obtaining the universal adjustment. Nevertheless, the angular adjustment is inconvenient, and the assembly of the connecting member 23, the first knob 221, and the second knob 241 is complicated. The disengagement of the cavities 2311, 2321, 2312, 2322 from the first knob 221 and the second knob 241 will happen after using the rod tool in a long period of time.

The present invention has arisen to mitigate and/or obviate the afore-described disadvantages.

### SUMMARY OF THE INVENTION

The primary object of the present invention is to provide a rod tool structure that is capable of being adjusted at various angles based on requirement.

Further object of the present invention is to provide a rod tool structure that is simply and assembled easily.

Another object of the present invention is to provide a rod tool structure, of which a front end of a flexible member fits with different tool members based on requirement.

To obtain the above objectives, a rod tool structure provided by the present invention contains:

a grip portion to be held by a hand;

an extendible and retractable tube connected with a front end of the grip portion to adjust an operation length; a flexible member mounted on a front end of the extendible and retractable tube and twisted at various angles;

a tool member connected with a front end of the flexible member to be operated and used;

wherein between the front end of the flexible member and the tool member is a connecting mechanism to fit different tool members with the front end of the flexible member.

### BRIEF DESCRIPTION OF THE DRAWINGS

FIG. 1 is a perspective view showing the exploded components of a conventional rod tool;

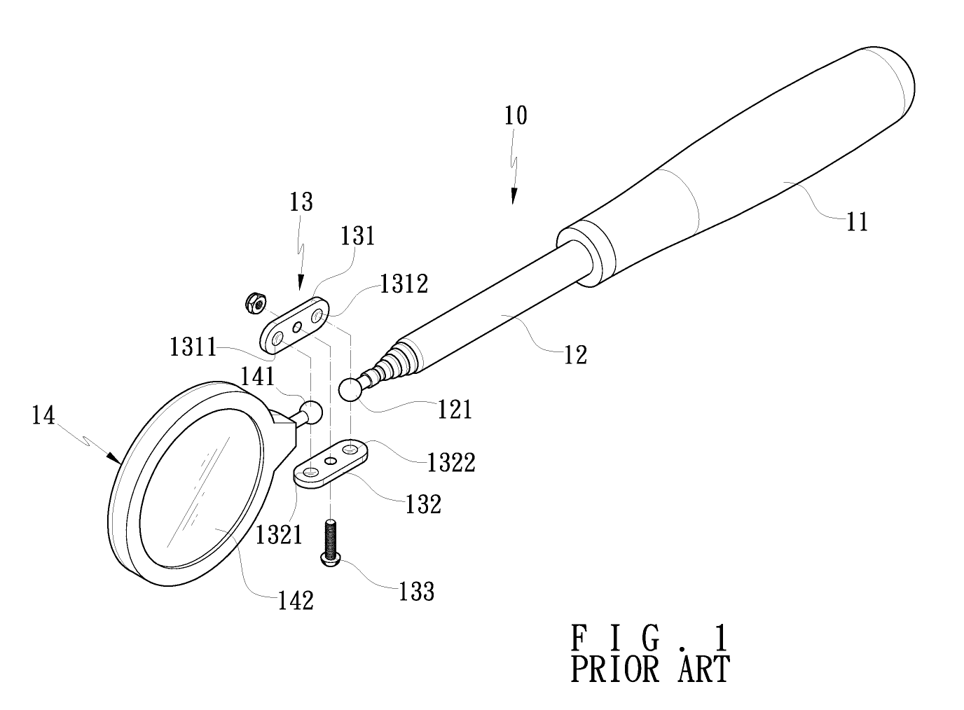

FIG. 2 is a perspective view showing the assembly of a conventional rod tool;

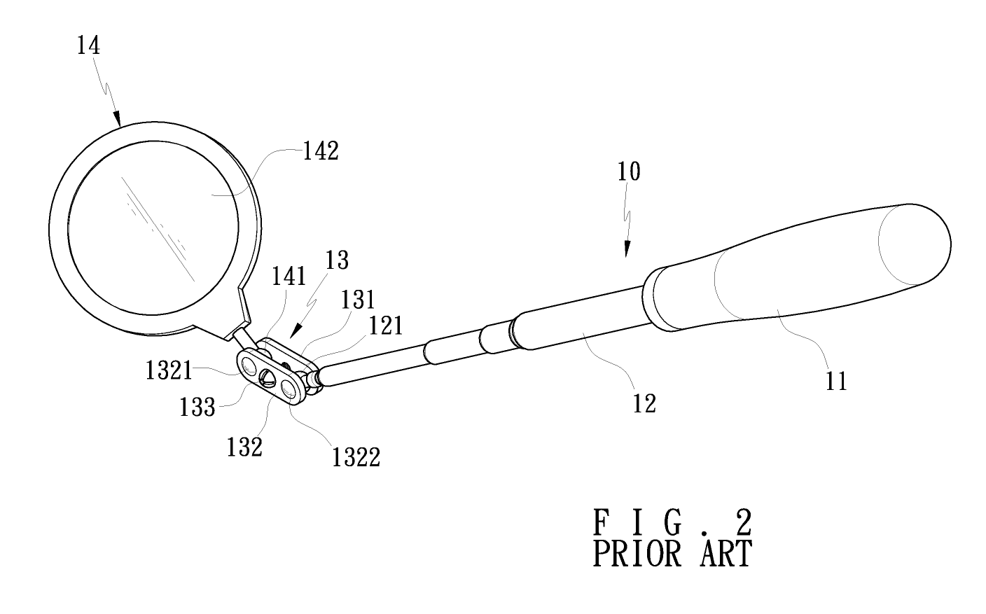

FIG. 3 is a perspective view showing the exploded components of another conventional rod tool;

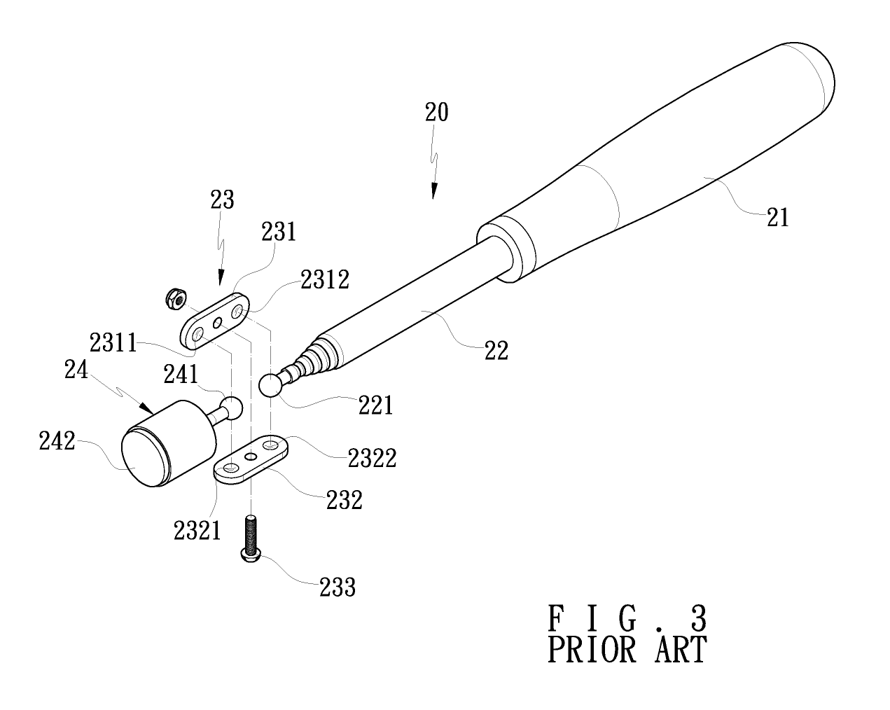

FIG. 4 is a perspective view showing the assembly of another conventional rod tool;

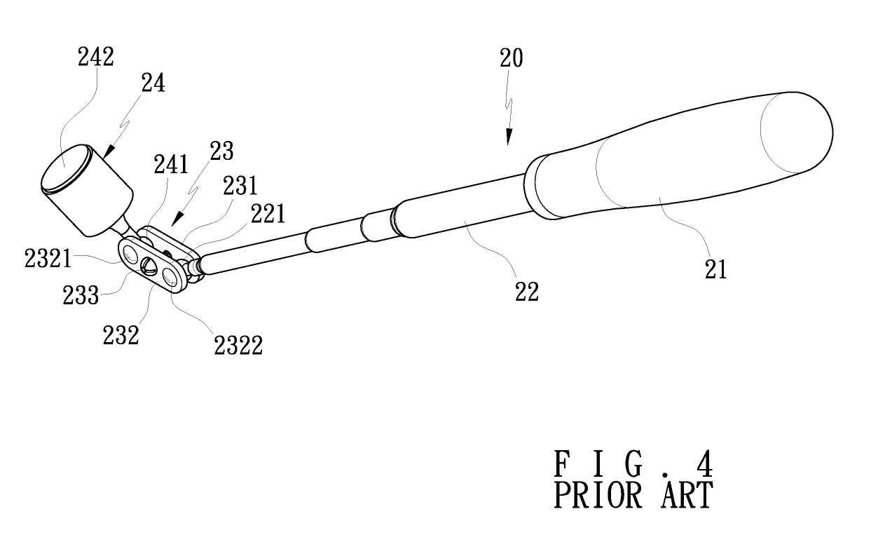

FIG. 5 is a perspective view showing the exploded components of a rod tool structure according to a first embodiment of the present invention;

FIG. 6 is a perspective view showing the assembly of the rod tool structure according to the first embodiment of the present invention;

FIG. 7 is a perspective view showing the exploded components of a rod tool structure according to a second embodiment of the present invention;

FIG. 8 is a perspective view showing the assembly of the rod tool structure according to the second embodiment of the present invention;

FIG. 9 is a perspective view showing the exploded components of a rod tool structure according to a third embodiment of the present invention;

FIG. 10 is a perspective view showing the exploded components of a rod tool structure according to a fourth embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

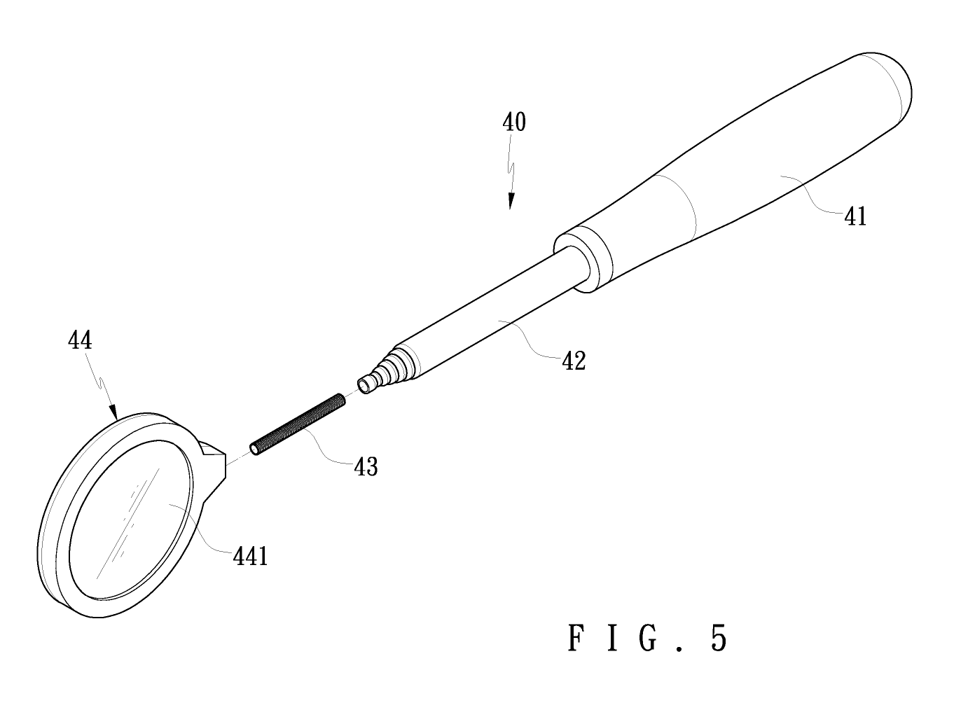

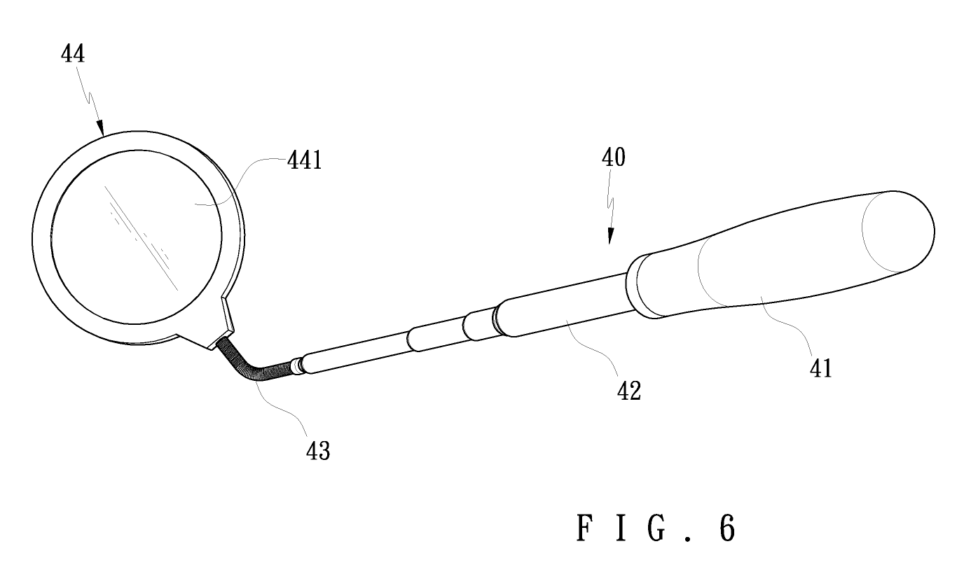

Referring to FIG. 5, a rod tool structure according to a first embodiment of the present patent comprises a body 40 with a mirror, the body 40 includes a hollowly rod-shaped grip portion 41 to be held by a hand, the grip portion 41 includes a multi-section extendible and retractable tube 42 connected with a front end thereof to adjust an operation length of the body 40, the extendible and retractable tube 42 is stored in the grip portion 41 and includes a flexible member 43 mounted on a front end thereof, the flexible member 43 is twisted by the hand at various angles and is positioned at a desired angle. The flexible member 43 includes a tool member 44 connected with a front end thereof. In this embodiment, the tool member 44 includes the mirror 441 to be used in the automotive repair and maintenance so that a user operates the rod tool structure in a narrow space of an engine room. Referring to FIG. 6, in operation, the operation length of the body 40 is adjusted by the extending or retracting tube 42, and then the flexible member 43 is twisted by the hand at the desired angle so that the mirror 441 of the tool member 44 matches with the narrow space of the engine room to make a universal adjustment and illumination in the narrow space. Thereby, the rod tool structure is simply, assembled easily, and adjusted at any angles.

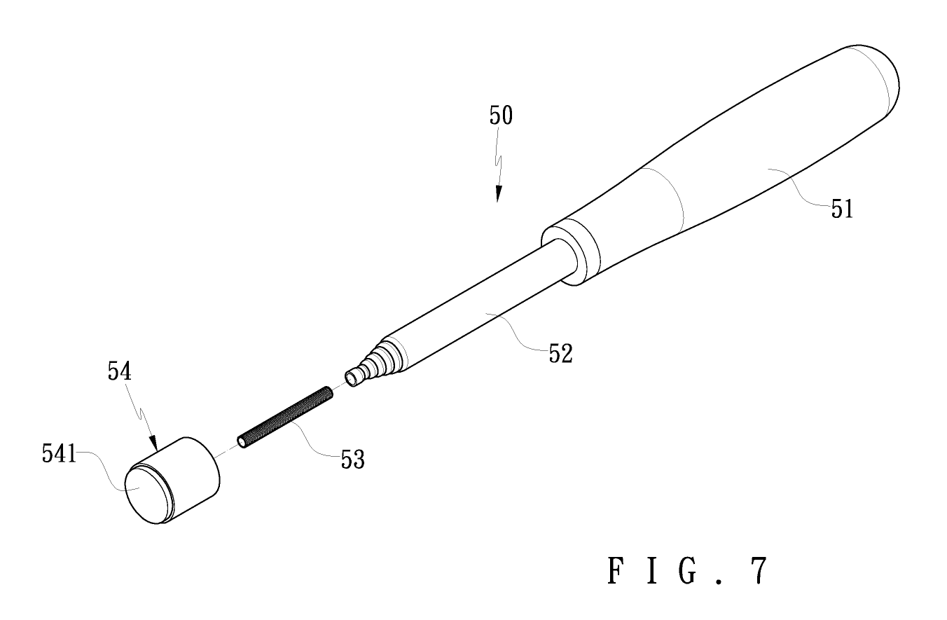

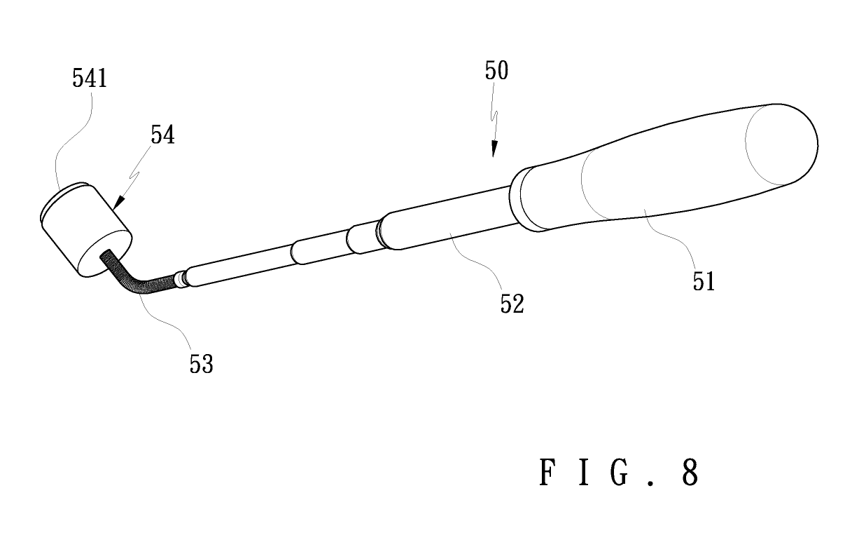

As shown in FIG. 7, a rod tool structure according to a second embodiment of the present patent comprises a body 50 with a magnetic member, the body 50 includes a hollowly rod-shaped grip portion 51 to be held by a hand, the grip portion 51 includes a multi-section extendible and retractable tube 52 connected with a front end thereof to adjust an operation length of the body 50, the extendible and retractable tube 52 is stored in the grip portion 51 and includes a flexible member 53 mounted on a front end thereof, the flexible member 53 is twisted by the hand at various angles and is positioned at a desired angle. The flexible member 53 includes a tool member 54 connected with a front end thereof. In this embodiment, the tool member 54 includes the magnetic member 541 to attract an object in a narrow space. Referring to FIG. 8, in operation, the operation length of the body 50 is adjusted by the extending or retracting tube 52, and then the flexible member 53 is twisted by the hand at the desired angle so that the magnetic member 541 of the tool member 54 matches with the narrow space of the engine room to make a universal adjustment and to attract the object in the narrow space. Thereby, the rod tool structure is simply, assembled easily, and adjusted at any angles.

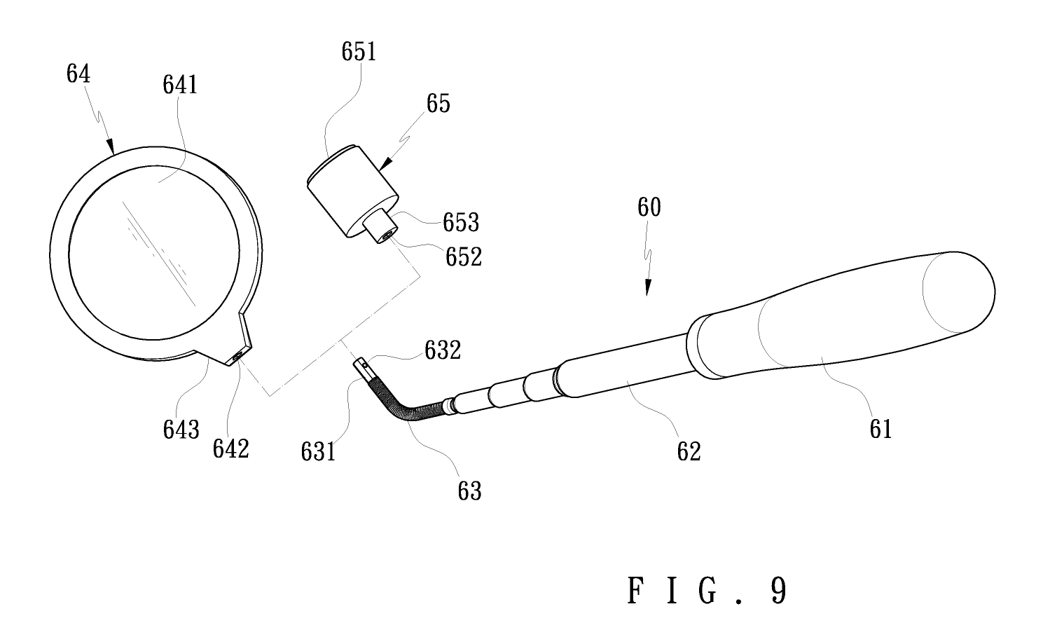

As illustrate in FIG. 9, a rod tool structure according to a third embodiment of the present patent comprises a body 60, the body 60 includes a hollowly rod-shaped grip portion 61 to be held by a hand, the grip portion 61 includes a multi-section extendible and retractable tube 62 connected with a front end thereof to adjust an operation length of the body 60, the extendible and retractable tube 62 is stored in the grip portion 61 and includes a flexible member 63 mounted on a front end thereof, the flexible member 63 is twisted by the hand at various angles and is positioned at a desired angle. The flexible member 63 includes a tool member connected with a front end thereof, wherein between the front end of the flexible member 63 and the tool member is a connecting mechanism. The connecting mechanism of the third embodiment of the present invention comprises a polygonal fitting post 631 fixed on a front end of the flexible member 63, and an elastic retaining member secured on at least one side of the polygonal fitting post 631. In this embodiment, the retaining member is a ball 632, and the tool member is in different types. In this embodiment, the tool member is a first tool member 64 with a mirror 641 or a second tool member 65 with a magnetic member 651. The first tool member 64 includes a first seat 643 which is disposed on a rear end of the first tool member 64 and has a polygonal hole 642 to fit with the fitting post 631 of the flexible member 63 and is retained by the ball 632. The second tool member 65 includes a second seat 653 which is secured on a rear end of the second tool member 65 and has a polygonal orifice 652 to fit with the fitting post 631 of the flexible member 63 and is retained by the ball 632 so that the front end of the flexible member 63 fits with different tool members based on requirement.

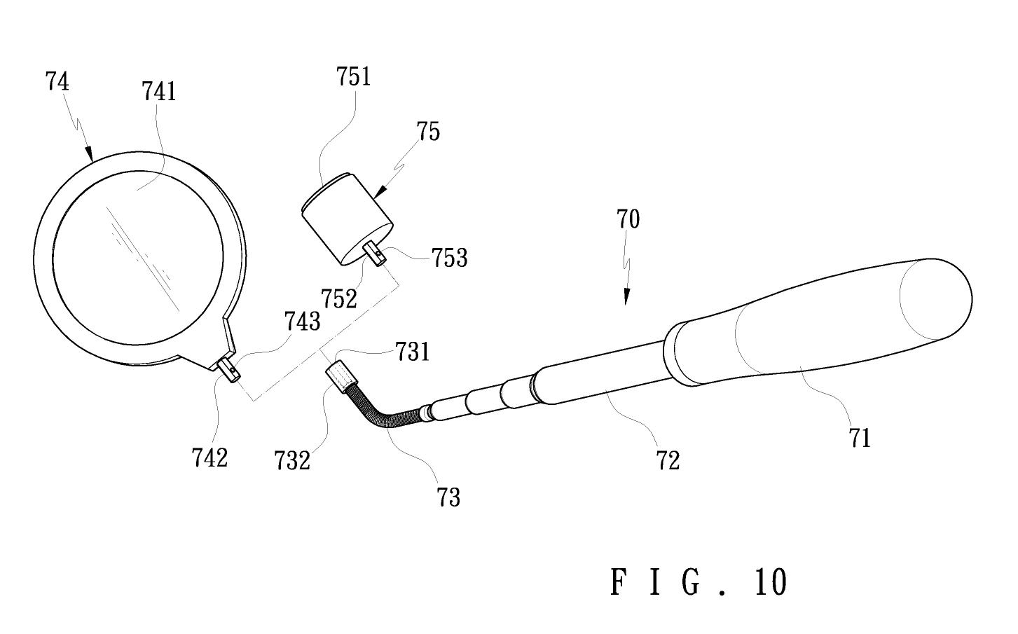

As illustrate in FIG. 10, a rod tool structure according to a fourth embodiment of the present patent comprises a body 70, the body 70 includes a hollowly rod-shaped grip portion 71 to be held by a hand, the grip portion 71 includes a multi-section extendible and retractable tube 72 connected with a front end thereof to adjust an operation length of the body 70, the extendible and retractable tube 72 is stored in the grip portion 71 and includes a flexible member 73 mounted on a front end thereof, the flexible member 73 is twisted by the hand at various angles and is positioned at a desired angle. The flexible member 73 includes a tool member connected with a front end thereof, wherein between the front end of the flexible member 73 and the tool member is a connecting mechanism. The connecting mechanism of the fourth embodiment of the present invention comprises a seat 732 which is fixed on a front end of the flexible member 73 and has a polygonal hole 731, and the tool member is in different types. In this embodiment, the tool member is a first tool member 74 with a mirror 741 or a second tool member 75 with a magnetic member 751. The first tool member 74 includes a first polygonal fitting post 742 which is disposed on a rear end of the first tool member 74 and has a first elastic retaining member secured on at least one side of the first polygonal fitting post 742. In this embodiment, the first elastic retaining member is a first ball 743 to retain the fitting post 742 of the first tool member 74 with the seat 732 of the flexible member 73. The second tool member 75 includes a second polygonal fitting post 752 which is disposed on a rear end of the second tool member 75 and has a second elastic retaining member secured on at least one side of the second polygonal fitting post 752. In this embodiment, the second elastic retaining member is a second ball 753 to retain the second polygonal fitting post 752 of the second tool member 75 with the seat 732 of the flexible member 73 so that the front end of the flexible member 73 fits with different tool members based on requirement.

While we have shown and described various embodiments in accordance with the present invention, it is clear to those skilled in the art that further embodiments may be made without departing from the scope of the present invention.

What is claimed is:

1. A rod tool structure comprising:
a grip portion to be held by a hand;
an extendible and retractable tube connected with a front end of the grip portion to adjust an operation length;
a flexible member mounted on a front end of the extendible and retractable tube and twisted at various angles;
a tool member connected with a front end of the flexible member to be operated and used.

2. The rod tool structure as claimed in claim 1, wherein the tool member is a mirror.

3. The rod tool structure as claimed in claim 1, wherein the tool member includes a magnetic member to attract an object.

4. The rod tool structure as claimed in claim 1, wherein between the front end of the flexible member and the tool member is a connecting mechanism to fit different tool members with the front end of the flexible member.

5. The rod tool structure as claimed in claim 4, wherein the connecting mechanism includes a polygonal fitting post fixed on the front end of the flexible member and an elastic retaining member secured on at least one side of the polygonal fitting post, the tool member includes a seat which is disposed on a rear end of the tool member and has a polygonal hole to fit with the fitting post of the flexible member.

6. The rod tool structure as claimed in claim 5, wherein the retaining member of the fitting post is a ball.

7. The rod tool structure as claimed in claim 4, wherein the connecting mechanism includes a seat which is fixed on the front end of the flexible member and has a polygonal hole, and the tool member includes a polygonal fitting post which is disposed on the rear end of the tool member and has an elastic retaining member secured on at least one side of the polygonal fitting post to retain with the seat of the flexible member.

8. The rod tool structure as claimed in claim 7, wherein the retaining member of the fitting post is a ball.
